(19) United States
(12) Patent Application Publication
(10) Pub. No.: US 2016/0175649 A1
(43) Pub. Date: Jun. 23, 2016

(54) EXERCISE ANALYSIS DEVICE, EXERCISE ANALYSIS METHOD, PROGRAM, RECORDING MEDIUM, AND EXERCISE ANALYSIS SYSTEM

(71) Applicant: SEIKO EPSON CORPORATION, Tokyo (JP)

(72) Inventor: Masaki UKAWA, Chino-shi (JP)

(73) Assignee: SEIKO EPSON CORPORATION, Tokyo (JP)

(21) Appl. No.: 14/965,284

(22) Filed: Dec. 10, 2015

(30) Foreign Application Priority Data
Dec. 18, 2014 (JP) 2014-256611

(51) Int. Cl. A63B 24/00; G01P 15/02; G01P 3/00; G01P 13/02

(52) U.S. Cl. CPC A63B 24/0006; G01P 13/02; G01P 15/02; G01P 3/00; A63B 2024/0012

(57) ABSTRACT

A first imaginary plane specifying unit specifies a first axis which lies in a longitudinal direction of a shaft of an exercise tool at an address posture of a user, using an output of an inertial sensor. A second imaginary plane specifying unit specifies a second axis forming a predetermined angle along with the first axis, using a hitting direction as a rotation axis. An exercise analysis unit calculates a trajectory of a swing of the user based on an output of the inertial sensor. An incident direction determination unit determines an incident direction of the trajectory on a region specified based on the first and second axes in a downswing.

### BACKGROUND

1. Technical Field

The present invention relates to an exercise analysis device, an exercise analysis method, a program, a recording medium, and an exercise analysis system.

2. Related Art

JP-A-2010-82430 discloses that an image is acquired by performing photographing from the rear side in a hitting direction between an address state to the end of a swing and the image is split into at least three regions by a first straight line passing through a shaft axis of a golf club in the address state and a second straight line intersecting the first straight line and passing through the root of an installed tee and the base of the neck of a golfer.

However, a V zone is known as an index for indicating goodness and badness of a swing. In general, when a trajectory of a swing is included in a V zone, the swing is estimated to be a type of straight-based swing.

In JP-A-2010-82430, a golfer at the time of address is photographed from the rear side of the hitting direction using a camera and, for example, a user draws a line in the photographed image to specify a V zone. In JP-A-2010-82430, the golfer performing a swing is photographed using a camera and it is visually confirmed whether a trajectory of the swing of the golfer is contained in the V zone drawn by the user. Therefore, in JP-A-2010-82430, there is a problem that it is difficult to estimate a type of swing.

### SUMMARY

An advantage of some aspects of the invention is that it provides a technology for simply estimating a type of swing.

A first aspect of the invention is directed to an exercise analysis device including: a first specifying unit that specifies a first axis which lies in a longitudinal direction of a shaft of an exercise tool at an address posture of a user, using an output of an inertial sensor; a second specifying unit that specifies a second axis forming a predetermined angle along with the first axis, using a hitting direction as a rotation axis; an analysis unit that calculates a trajectory of a swing of the user based on an output of the inertial sensor; and an incident direction determination unit that determines an incident direction of the trajectory on a region specified based on the first and second axes in a downswing. According to the first aspect of the invention, the exercise analysis device determines the incident direction of the trajectory in the region specified based on the first and second axes in the downswing, thus, the user can simply estimate type of swing.

The exercise analysis device may further include a type determination unit that determines a type of swing of the user based on the incident direction of the trajectory. With this configuration, the exercise analysis device can estimate the type of swing of the user based on the incident direction of the trajectory, and thus the user can simply estimate the type of swing.

The first specifying unit may specify a first imaginary plane including the first axis and the hitting direction. The second specifying unit may specify a second imaginary plane including the second axis and the hitting direction. When the trajectory is incident from the first imaginary plane, the type determination unit may determine that the type of swing of the user is a type of slice. When the trajectory is incident from the second imaginary plane, the type determination unit may determine that the type of swing of the user is a type of hook. When the trajectory is not incident from either the first imaginary plane nor the second imaginary plane, the type determination unit may determine that the type of swing of the user is a type of straight. With this configuration, the exercise analysis device can simply estimate whether the type of swing of the user is the type of slice, the type of hook, or the type of straight.

A plurality of the trajectories of the swings may be obtained. The type determination unit may determine the type of swing of the user based on the incident directions of the trajectories formed by the plurality of swings. With this configuration, the user can recognize his or her swing tendency.

The incident direction determination unit may determine an incident direction of a section from a halfway-down to impact in the downswing. With this configuration, the exercise analysis device can determine the type of swing more accurately.

The exercise analysis device may further include an exit direction determination unit that determines an exit direction of the trajectory from the region after impact. With this configuration, the exercise analysis device can determine the type of swing more minutely.

The exercise analysis device may further include a type determination unit that determines a type of swing of the user based on the incident direction of the trajectory and the exit direction of the trajectory. With this configuration, the exercise analysis device can determine the type of swing more minutely.

The first specifying unit may specify a first imaginary plane including the first axis and the hitting direction. The second specifying unit may specify a second imaginary plane including the second axis and the hitting direction. When the trajectory is incident from the first imaginary plane, the type determination unit may determine that the type of swing of the user is a type of slice. When the trajectory is incident from the second imaginary plane, the type determination unit may determine that the type of swing of the user is a type of hook. When the trajectory is not incident from either the first imaginary plane nor the second imaginary plane, the type determination unit may determine that the type of swing of the user is a type of straight. Thus, the exercise analysis device can simply estimate whether the type of swing of the user is the type of slice, the type of hook, or the type of straight.

A plurality of the trajectories of the swings may be obtained. The type determination unit may determine the type of swing of the user based on the incident directions of the trajectories formed by the plurality of swings. With this configuration, the user can recognize his or her swing tendency.

A second aspect of the invention is directed to an exercise analysis method of the exercise analysis device. The exercise analysis method includes: specifying a first axis which lies in a longitudinal direction of a shaft of an exercise tool at an address posture of a user, using an output of an inertial sensor; specifying a second axis forming a predetermined angle along with the first axis, using a hitting direction as a rotation axis; calculating a trajectory of a swing of the user based on an output of the inertial sensor; and determining an incident direction of the trajectory on a region specified based on the first and second axes in a downswing. According to the second aspect of the invention, since the exercise analysis device determines the incident direction of the trajectory on the region specified based on the first and second axes in the downswing, the user can simply estimate the type of swing.

A third aspect of the invention is directed to a program causing a computer to perform: specifying a first axis which lies in a major axis direction of a shaft of an exercise tool at an address posture of a user, using an output of an inertial sensor; specifying a second axis forming a predetermined angle along with the first axis, using a hitting direction as a rotation axis; calculating a trajectory of a swing of the user based on an output of the inertial sensor; and determining an incident direction of the trajectory on a region specified based on the first and second axes in a downswing. According to the third aspect of the invention, since the computer determines the incident direction of the trajectory on the region specified based on the first and second axes in the downswing, the user can simply estimate the type of swing.

Another aspect of the invention is directed to a recording medium that records a program causing a computer to perform: specifying a first axis which lies in a major axis of a shaft of an exercise tool at an address posture of a user, using an output of an inertial sensor; specifying a second axis forming a predetermined angle along with the first axis, using a hitting direction as a rotation axis; calculating a trajectory of a swing of the user based on an output of the inertial sensor; and determining an incident direction of the trajectory on a region specified based on the first and second axes in a downswing.

A fourth aspect of the invention is directed to an exercise analysis system including: an inertial sensor; a first specifying unit that specifies a first axis which lies in a longitudinal direction of a shaft of an exercise tool at an address posture of a user, using an output of the inertial sensor; a second specifying unit that specifies a second axis forming a predetermined angle along with the first axis, using a hitting direction as a rotation axis; an analysis unit that calculates a trajectory of a swing of the user based on an output of the inertial sensor; and an incident direction determination unit that determines an incident direction of the trajectory on a region specified based on the first and second axes in a downswing.

According to the fourth aspect of the invention, since the exercise analysis system determines the incident direction of the trajectory on the region specified based on the first and second axes in the downswing, the user can simply estimate the type of swing.

The exercise analysis system may further include a type determination unit that determines a type of swing of the user based on the incident direction.

With this configuration, the exercise analysis system can estimate the type of swing of the user based on the incident direction of the trajectory, and thus the user can simply estimate the type of swing.

In the exercise analysis system, the first specifying unit may specify a first imaginary plane including the first axis and the hitting direction. The second specifying unit may specify a second imaginary plane including the second axis and the hitting direction. When the trajectory is incident from the first imaginary plane, the type determination unit may determine that the type of swing of the user is a type of slice. When the trajectory is incident from the second imaginary plane, the type determination unit may determine that the type of swing of the user is a type of hook. When the trajectory is not incident from either the first imaginary plane nor the second imaginary plane, the type determination unit may determine that the type of swing of the user is a type of straight.

With this configuration, the exercise analysis system can simply estimate whether the type of swing of the user is the type of slice, the type of hook, or the type of straight.

Still another aspect of the invention is directed to an exercise analysis device including an incident direction determination unit that determines an incident direction of a swing trajectory of a user on a V zone in a downswing.

The exercise analysis device may further include a type determination unit that determines a type of swing of the user based on the incident direction.

A plurality of the swing trajectories may be obtained. The type determination unit may determine the type of swing of the user based on the incident directions of the plurality of swing trajectories.

The incident direction determination unit may determine an incident direction of a section from a halfway-down to impact in the downswing.

The exercise analysis device may further include an exit direction determination unit that determines an exit direction of the swing trajectory from the V zone after impact.

The exercise analysis device may further include a type determination unit that determines a type of swing of the user based on the incident direction of the swing trajectory and the exit direction of the swing trajectory.

### BRIEF DESCRIPTION OF THE DRAWINGS

The invention will be described with reference to the accompanying drawings, wherein like numbers reference like elements.

FIG. 1 is a diagram illustrating an overview of an exercise analysis system according to an embodiment of the invention.

FIG. 2 is a diagram illustrating examples of a shaft plane and a Hogan's plane.

FIG. 3 is a block diagram illustrating an example of the configuration of an exercise analysis system.

FIG. 4 is a flowchart illustrating an example of an exercise analysis process.

FIG. 5 is a plan view illustrating a golf club and a sensor unit at the time of stopping of a user when viewed from the negative side of the X axis.

FIG. 6 is a diagram illustrating a cross section obtained by cutting the shaft plane along the YZ plane when viewed from the negative side of the X axis.

FIG. 7 is a diagram illustrating a cross section obtained by cutting the Hogan's plane along the YZ plane when viewed from the negative side of the X axis.

FIG. 8 is a diagram illustrating examples of angular velocities output from the sensor unit.

FIG. 9 is a diagram illustrating an example of a norm of an angular velocity.

FIG. 10 is a diagram illustrating an example of a differential value of the norm of an angular velocity.

FIG. 11 is a diagram (a diagram projected to the YZ plane) illustrating the shaft plane and the Hogan's plane when viewed from the negative side of the X axis.

FIG. 12 is a diagram illustrating an example of a screen displayed on a display unit.

FIG. 13 is a flowchart illustrating an example of operations of an incident direction determination unit and a type determination unit.

### DESCRIPTION OF EXEMPLARY EMBODIMENTS

Hereinafter, embodiments of the invention will be described with reference to the drawings. Hereinafter, an exercise analysis system performing analysis of a golf swing will be described as an example.

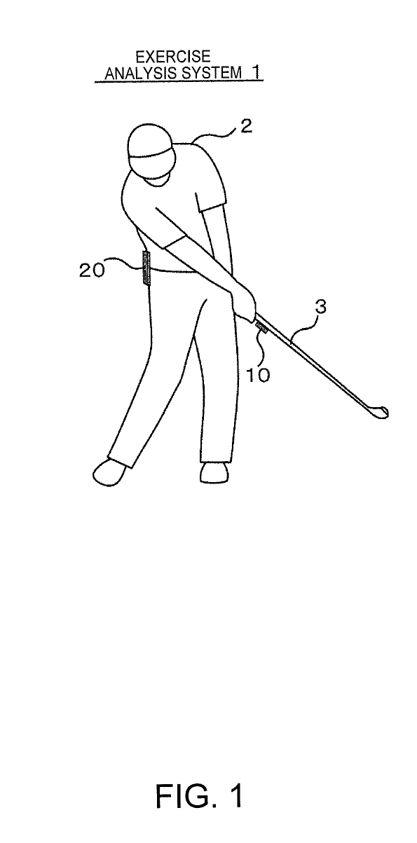

FIG. 1 is a diagram illustrating an overview of an exercise analysis system according to an embodiment of the invention.

An exercise analysis system 1 includes a sensor unit 10 and an exercise analysis device 20.

The sensor unit 10 can measure acceleration generated in each axis direction of three axes and an angular velocity generated in each rotation of the three axes as an inertial sensor and is mounted on a golf club 3. For example, the sensor unit 10 is fitted on a part of the shaft of the golf club 3 when one axis among three detection axes (the x axis, the y axis, and the z axis), for example, the y axis, conforms to the major axis direction (longitudinal direction) of the shaft. Preferably, the sensor unit 10 is fitted at a position close to a grip in which a shock at the time of a shot is rarely delivered and a centrifugal force is not applied at the time of a swing. The shaft is a portion of the handle excluding the head of the golf club 3 and also includes the grip.

A user 2 performs a swing motion of hitting a golf ball (not illustrated) in a pre-decided procedure. For example, the user 2 first holds the golf club 3, takes a posture of address so that the major axis direction (longitudinal direction) of the shaft of the golf club 3 is vertical to a target line (for example, a hitting target direction), and stops for a predetermined time or more (for example, 1 second or more). Next, the user 2 performs a swing motion to hit the golf ball. The posture of address in the present specification includes a posture in a stop state of the user before start of a swing or a posture in a state in which the user shakes an exercise tool (waggling) before start of a swing. The target line refers to any hitting direction and is decided as, for example, a hitting target direction in the embodiment.

While the user 2 performs the motion to hit the golf ball in the above-described procedure, the sensor unit 10 measures triaxial acceleration and triaxial angular velocities at a predetermined period (for example, 1 ms) and sequentially transmits the measurement data to the exercise analysis device 20. The sensor unit 10 may immediately transmit the measurement data, or may store the measurement data in an internal memory and transmit the measurement data at a desired timing such as the end of a swing motion of the user 2. Communication between the sensor unit 10 and the exercise analysis device 20 may be wireless communication or wired communication. Alternatively, the sensor unit 10 may store the measurement data in a recording medium such as a memory card which can be detachably mounted and the exercise analysis device 20 may read the measurement data from the recording medium.

The exercise analysis device 20 analyzes a swing exercise performed with the golf club 3 by the user 2 using the data measured by the sensor unit 10. In particular, in the embodiment, the exercise analysis device 20 specifies a shaft plane (which corresponds to a first imaginary plane or a first axis according to the invention) and a Hogan's plane (which corresponds to a second imaginary plane or a second axis according to the invention) at the time of stopping of the user 2 (the time of address) using the data measured by the sensor unit 10.

The exercise analysis device 20 calculates a trajectory of the golf club 3 (for example, a trajectory of the head) at a swing after the user 2 starts the swing motion. The exercise analysis device 20 determines an incident direction of the trajectory of the golf club 3 in a downswing in a region referred to as a V zone between the shaft plane and the Hogan's plane and determines a type of swing of the user 2 based on the determined incident direction. The exercise analysis device 20 generates image data including the trajectory of the golf club 3 in the swing of the user 2, the shaft plane, the Hogan's plane, and information of the type of swing of the user 2 and causes a display unit to display an image according to the image data.

The exercise analysis device 20 may be, for example, a portable device such as a smartphone or a personal computer (PC). In FIG. 1, the exercise analysis device 20 is mounted on the waist of the user 2, but the mounted position is not particularly limited. Further, the exercise analysis device 20 may not be mounted on the user 2.

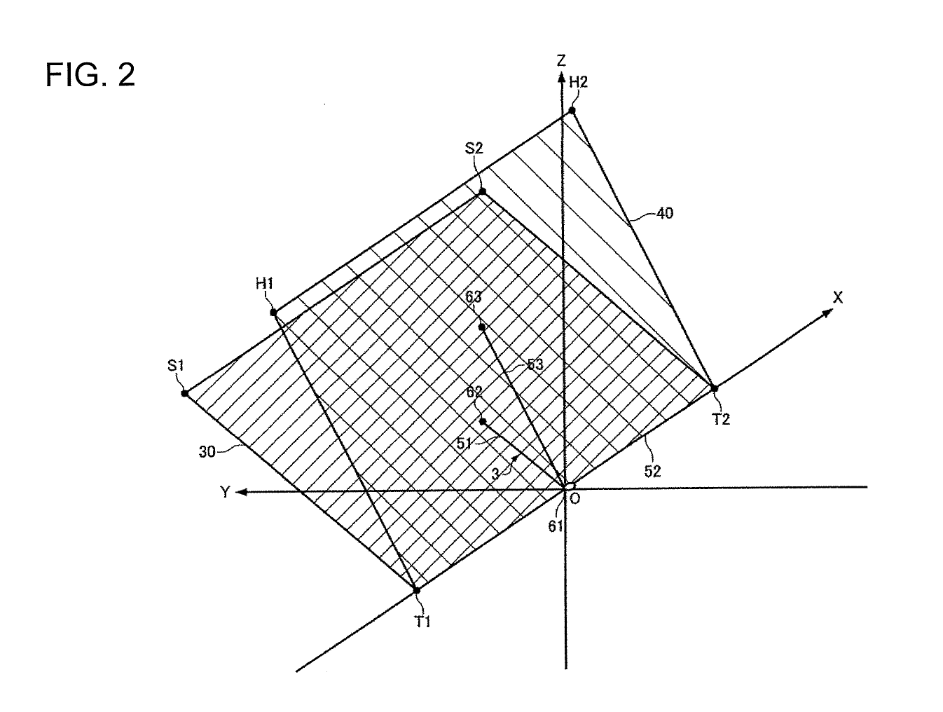

FIG. 2 is a diagram illustrating examples of the shaft plane and the Hogan's plane. In the embodiment, an XYZ coordinate system (global coordinate system) in which a target line indicating a hitting target direction is an X axis, an axis on a horizontal plane vertical to the X axis is a Y axis, and an upward vertical direction (which is an opposite direction to the direction of the gravity acceleration) is a Z axis is defined. In FIG. 2, the X, Y, and Z axes are shown.

A shaft plane 30 at the time of address of the user 2 is an imaginary plane which includes a first line segment 51 serving as a first axis which lies in the major axis direction of the shaft of the golf club 3 and a third line segment 52 serving as a third axis indicating a hitting target direction and has four vertexes T1, T2, S1, and S2. In the embodiment, a position 61 of the head (blow portion) of the golf club 3 is set as the origin O (0, 0, 0) of the XYZ coordinate system. The first line segment 51 is a line segment which connects the position 61 (the origin O) of the head of the golf club 3 to a position 62 of a grip end. The third line segment 52 is a line segment which has T1 and T2 on the X axis as both ends, has a length TL, and centers on the origin O. When the user 2 takes the above-described address posture at the time of the address, the shaft of the golf club 3 is vertical to the target line (the X axis). Therefore, the third line segment 52 is a line segment which is perpendicular to the major axis direction of the shaft of the golf club 3, that is, a line segment perpendicular to the first line segment 51. The shaft plane 30 is specified by calculating the coordinates of the four vertexes T1, T2, S1, and S2 in the XYZ coordinate system. A method of calculating the coordinates of the four vertexes T1, T2, S1, and S2 will be described in detail below.

The Hogan's plane 40 is an imaginary plane which includes the third line segment 52 and a second line segment 53 serving as a second axis and has four vertexes T1, T2, H1, and H2. In the embodiment, the second line segment 53 is a line segment which connects the position 62 (which is an example of a blow position) of the head (which is a blow portion) of the golf club 3 to a predetermined position 63 (which is, for example, the position of the base of the neck or the position of one of the right and left shoulders) on a line segment connecting both shoulders of the user 2 to one another. Here the second line segment 53 may be a line segment which connects the predetermined position 63 to the position (which is an example of the blow position) of a ball at the time of address. The Hogan's plane 40 is specified by calculating the coordinates of the four vertexes T1, T2, H1, and H2 in the XYZ coordinate system. A method of calculating the coordinates of the four vertexes T1, T2, H1, and H2 will be described in detail below.

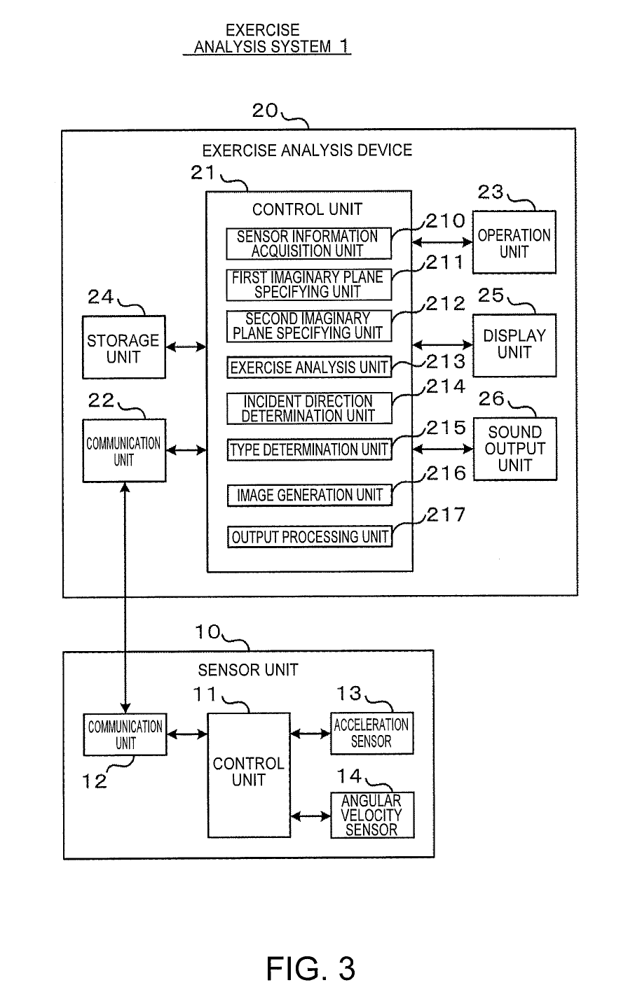

FIG. 3 is a block diagram illustrating an example of the configuration of an exercise analysis system.

The sensor unit 10 includes a control unit 11, a communication unit 12, an acceleration sensor 13, and an angular velocity sensor 14.

The acceleration sensor 13 measures acceleration generated in each of mutually intersecting (ideally, orthogonal) triaxial directions and outputs digital signals (acceleration data) according to the sizes and directions of the measured triaxial accelerations.

The angular velocity sensor 14 measures an angular velocity generated at axis rotation of mutually intersecting (ideally, orthogonal) three axes and outputs digital signals (angular velocity data) according to the sizes and directions of the measured triaxial angular velocities.

The control unit 11 controls the sensor unit in an integrated manner. The control unit 11 receives the acceleration data and the angular velocity data from the acceleration sensor 13 and the angular velocity sensor 14, appends time information, and stores the acceleration data and the angular velocity data in a storage unit (not illustrated). The control unit 11 generates packet data in conformity to a communication format by appending time information to the stored measurement data (the acceleration data and the angular velocity data) and outputs the packet data to the communication unit 12.

The acceleration sensor 13 and the angular velocity sensor 14 are ideally fitted in the sensor unit 10 so that the three axes of each sensor match the three axes (the x axis, the y axis, and the z axis) of the rectangular coordinate system (sensor coordinate system) defined for the sensor unit 10, but errors of the fitting angles actually occur. Accordingly, the control unit 11 performs a process of converting the acceleration data and the angular velocity data into data of the xyz coordinate system, using correction parameters calculated in advance according to the errors of the fitting angles.

The control unit 11 may perform a temperature correction process of the acceleration sensor 13 and the angular velocity sensor 14. Alternatively, a temperature correction function may be embedded in the acceleration sensor 13 and the angular velocity sensor 14.

The acceleration sensor 13 and the angular velocity sensor 14 may output analog signals. In this case, the control unit 11 may perform A/D (analog/digital) conversion on each of an output signal of the acceleration sensor 13 and an output signal of the angular velocity sensor 14, generate measurement data (acceleration data and angular velocity data), and generate packet data for communication using the measurement data.

The communication unit 12 performs, for example, a process of transmitting the packet data received from the control unit 11 to the exercise analysis device 20 or a process of receiving control commands from the exercise analysis device 20 and transmitting the control commands to the control unit 11. The control unit 11 performs various processes according to the control commands.

The exercise analysis device 20 includes a control unit 21, a communication unit 22, an operation unit 23, a storage unit 24, a display unit 25, and a sound output unit 26.

The communication unit 22 performs, for example, a process of receiving the packet data transmitted from the sensor unit 10 and transmitting the packet data to the control unit 21 or a process of transmitting a control command from the control unit 21 to the sensor unit 10.

The operation unit 23 performs a process of acquiring operation data from the user and transmitting the operation data to the control unit 21. The operation unit 23 may be, for example, a touch panel type display, a button, a key, or a microphone.

The storage unit 24 is configured by, for example, any of various IC memories such as a read-only memory (ROM), a flash ROM, and a random access memory (RAM) or a recording medium such as a hard disk or a memory card.

The storage unit 24 stores, for example, programs used for the control unit 21 to perform various calculation processes or control processes, or various programs or data used for the control unit 21 to realize application functions. In particular, in the embodiment, the storage unit 24 stores an exercise analysis program which is read by the control unit 21 to perform an analysis process. The exercise analysis program may be stored in advance in a nonvolatile recording medium. Alternatively, the exercise analysis program may be received from a server via a network by the control unit 21 and may be stored in the storage unit 24.

In the embodiment, the storage unit 24 stores body information of the user 2, club specification information indicating the specification of the golf club 3, and sensor-mounted position information. For example, when the user 2 operates the operation unit 23 to input the body information such as a height, a weight, and a sex, the input body information is stored as body information in the storage unit 24. For example, the user 2 operates the operation unit 23 to input a model number of the golf club 3 (or selects the model number from a model number list) to be used and sets specification information regarding the input model number as the club specification information among pieces of specification information for each model number (for example, information regarding the length of the shaft, the position of the center of gravity, a lie angle, a face angle, a loft angle, and the like) stored in advance in the storage unit 24. For example, when the user 2 operates the operation unit 23 to input a distance between the position at which the sensor unit 10 is mounted and the grip end of the golf club 3, information regarding the input distance is stored as the sensor-mounted position information in the storage unit 24. Alternatively, by mounting the sensor unit 10 at a decided predetermined position (for example, a distance of 20 cm from the grip end), information regarding the predetermined position may be stored in advance as the sensor-mounted position information.

The storage unit 24 is used as a work area of the control unit 21 and temporarily stores, for example, data input from the operation unit 23 and calculation results performed according to various programs by the control unit 21. The storage unit 24 may store data necessarily stored for a long time among the data generated through the processes of the control unit 21.

The display unit 25 displays a processing result of the control unit 21 as text, a graph, a table, animations, or another image. The display unit 25 may be, for example, a cathode ray tube (CRT) display, a liquid crystal display (LCD), an electrophoretic display (EPD), a display using an organic light-emitting diode (OLED), a touch panel type display, or a head-mounted display (HMD). The functions of the operation unit 23 and the display unit 25 may be realized by one touch panel type display.

The sound output unit 26 outputs a processing result of the control unit 21 as audio such as a sound or a buzzer tone. The sound output unit 26 may be, for example, a speaker or a buzzer.

The control unit 21 performs a process of transmitting a control command to the sensor unit 10, various calculation processes on data received from the sensor unit 10 via the communication unit 22, and other various control processes according to various programs. In particular, in the embodiment, the control unit 21 executes an exercise analysis program to function as a sensor information acquisition unit 210, a first imaginary plane specifying unit 211 (which corresponds to a first specifying unit according to the invention), a second imaginary plane specifying unit 212 (which corresponds to a second specifying unit according to the invention), an exercise analysis unit 213 (which correspond to an analysis unit according to the invention), an incident direction determination unit 214, a type determination unit 215, an image generation unit 216, and an output processing unit 217. The first and second specifying units may be realized by separate calculation units or may be realized by the same calculation unit.

The control unit 21 may be realized by a computer that includes a central processing unit (CPU) which is a calculation device, a random access memory (RAM) which is a volatile storage device, a ROM which is a non-volatile storage device, an interface (I/F) circuit connecting the control unit 21 to the other units, and a bus mutually connecting these units. The computer may include various dedicated processing circuits such as image processing circuits. The control unit 21 may also be realized by an application specific integrated circuit (ASIC) or the like.

The sensor information acquisition unit 210 receives the packet data received from the sensor unit 10 by the communication unit 22 and acquires the time information and the measurement data from the received packet data. The sensor information acquisition unit 210 stores the acquired time information and measurement data in the storage unit 24 in association therewith.

The first imaginary plane specifying unit 211 performs a process of specifying the first line segment 51 in the major axis direction of the shaft of the golf club 3 at the time of stopping of the user, using the measurement data output by the sensor unit 10. Further, the first imaginary plane specifying unit 211 performs a process of specifying the shaft plane (first imaginary plane) 30 (see FIG. 2) including the first line segment 51 and the third line segment 52 indicating the hitting target direction.

The first imaginary plane specifying unit 211 may calculate the coordinates of the position 62 of the grip end of the golf club 3 using the measurement data output by the sensor unit 10 and specify the first line segment 51 based on the coordinates of the position 62 of the grip end. For example, the first imaginary plane specifying unit 211 may calculate an inclination angle (an inclination relative to the horizontal plane (the XY plane) or the vertical plane (the XZ plane)) of the shaft of the golf club 3, using the acceleration data measured by the acceleration sensor 13 at the time of stopping of the user 2 (the time of the address) and specify the first line segment 51 using the calculated inclination angle and information regarding the length of the shaft included in the club specification information.

The first imaginary plane specifying unit 211 may calculate the width of the shaft plane 30 using the length of an arm of the user 2 based on the body information and the length of the first line segment 51.

The second imaginary plane specifying unit 212 performs a process of specifying the second line segment 53 forming a predetermined angle relative to the first line segment 51 specified by the first imaginary plane specifying unit 211, using the hitting target direction (the third line segment 52) as the rotation axis. Further, the second imaginary plane specifying unit 212 performs a process of specifying the Hogan's plane (second imaginary plane) 40 (see FIG. 2) including the second line segment 53 and the third line segment 52.

For example, the second imaginary plane specifying unit 212 performs a process of estimating the predetermined position 63 between the head and the chest of the user 2 at the time of stopping of the user 2 (for example, on a line segment connecting both shoulders to one another) using the body information and the measurement data output by the sensor unit 10 and specifying the second line segment 53 connecting the estimated predetermined position 63 to the position 62 of the head (blow portion) of the golf club 3. The second imaginary plane specifying unit 212 performs a process of specifying the Hogan's plane (second imaginary plane) 40 (see FIG. 2) including the second line segment 53 and the third line segment 52.

The second imaginary plane specifying unit 212 may estimate the predetermined position 63 using the coordinates of the position 62 of the grip end calculated by the first imaginary plane specifying unit 211 and the length of the arm of the user 2 based on the body information. Alternatively, the second imaginary plane specifying unit 212 may calculate the coordinates of the position 62 of the grip end of the golf club 3 using the measurement data output by the sensor unit 10. In this case, the first imaginary plane specifying unit 211 may specify the shaft plane 30 using the coordinates of the position 62 of the grip end calculated by the second imaginary plane specifying unit 212.

The second imaginary plane specifying unit 212 may calculate the width of the Hogan's plane 40 using the length of the arm of the user 2 based on the body information and the length of the first line segment 51.

The exercise analysis unit 213 performs a process of analyzing a swing exercise of the user 2 using the measurement data output by the sensor unit 10. Specifically, the exercise analysis unit 213 first calculates an offset amount included in the measurement data using the measurement data (the acceleration data and the angular velocity data) at the time of stopping of the user 2 (the time of the address), which is stored in the storage unit 24. Next, the exercise analysis unit 213 subtracts the offset amount from the measurement data after start of a swing, which is stored in the storage unit 24 to correct a bias and calculates the position and posture of the sensor unit 10 during a swing motion of the user 2 using the measurement data in which the bias is corrected.

For example, the exercise analysis unit 213 calculates the position (initial position) of the sensor unit 10 at the time of stopping of the user 2 (the time of the address) in the XYZ coordinate system (global coordinate system), using the acceleration data measured by the acceleration sensor 13, the club specification information, and the sensor-mounted position information, integrates the subsequent acceleration data, and chronologically calculates a change in the position of the sensor unit 10 from the initial position. Since the user 2 stops at a predetermined address posture, the X coordinate of the initial position of the sensor unit 10 is 0. Further, the y axis of the sensor unit 10 is identical to the major axis direction of the shaft of the golf club 3, and the acceleration sensor 13 measures only the gravity acceleration at the time of stopping of the user 2. Therefore, the exercise analysis unit 213 can calculate an inclination angle of the shaft (an inclination relative to the horizontal plane (the XY plane) or the vertical plane (the XZ plane)), using y-axis acceleration data. Then, the exercise analysis unit 213 can calculate the Y and Z coordinates of the initial position of the sensor unit 10 using the inclination angle of the shaft, the club specification information (the length of the shaft), and the sensor-mounted position information (the distance from the grip end) and specify the initial position of the sensor unit 10. Alternatively, the exercise analysis unit 213 may calculate the coordinates of the initial position of the sensor unit 10 using the coordinates of the position 62 of the grip end of the golf club 3 calculated by the first imaginary plane specifying unit 211 or the second imaginary plane specifying unit 212 and the sensor-mounted position information (the distance from the grip end).

The exercise analysis unit 213 calculates the posture (initial posture) of the sensor unit 10 at the time of stopping of the user 2 (the time of the address) in the XYZ coordinate system (global coordinate system), using the acceleration data measured by the acceleration sensor 13, performs rotation calculation using the angular velocity data measured subsequently by the angular velocity sensor 14, and chronologically calculates a change in the posture from the initial posture of the sensor unit 10. The posture of the sensor unit 10 can be expressed by, for example, rotation angles (a roll angle, a pitch angle, and a yaw angle) around the X axis, the Y axis, and the Z axis, Eulerian angles, quaternions, or the like. At the time of stopping of the user 2, the acceleration sensor 13 measures only the gravity acceleration. Therefore, the exercise analysis unit 213 can specify an angle formed between of each of the x, y, and z axes of the sensor unit 10 and a gravity direction using triaxial acceleration data. Since the user 2 stops at the predetermined address posture, the y axis of the sensor unit 10 is present on the YZ plane at the time of stopping of the user 2. The exercise analysis unit 213 can specify the initial posture of the sensor unit 10.

The control unit 11 of the sensor unit 10 may calculate the offset amount of the measurement data and correct the bias of the measurement data or a bias correction function may be embedded in the acceleration sensor 13 and the angular velocity sensor 14. In this case, it is not necessary to correct the bias of the measurement data by the exercise analysis unit 213.

The exercise analysis unit 213 defines an exercise analysis model (a double pendulum model or the like) in consideration of the body information (the height (length of the arm) of the user 2), the club specification information (the length or the position of the center of the shaft), the sensor-mounted position information (the distance from the grip end), features (rigid body and the like) of the golf club 3, and features of a human body (for example, a joint bending direction is decided), and then calculates a trajectory of the golf club 3 at a swing of the user 2 using the exercise analysis model and the information regarding the position and posture of the sensor unit 10.

The exercise analysis unit 213 detects a timing (a timing of impact) at which a ball is hit during a period of a swing motion of the user 2, using time information and the measurement data stored in the storage unit 24. For example, the exercise analysis unit 213 calculates a composite value of the measurement data (the acceleration data or the angular velocity data) output by the sensor unit 10 and specifies a timing (time) at which the user 2 hits the ball based on the composite value.

Using the exercise analysis model and information regarding the position and posture of the sensor unit 10, the exercise analysis unit 213 may generate, for example, a rhythm of a swing from a backswing to follow-through, a head speed, an incident angle (club pass) or a face angle at the time of hitting, shaft rotation (a change amount of face angle during a swing), information regarding a deceleration rate or the like of the golf club 3, or information regarding a variation in each piece of information when the user 2 performs the swing a plurality of times.

The incident direction determination unit 214 determines an incident direction of the trajectory of the golf club 3 calculated by the exercise analysis unit 213 on the V zone (a region between the shaft plane 30 specified by the first imaginary plane specifying unit 211 and the Hogan's plane 40 specified by the second imaginary plane specifying unit 212) in a downswing. The downswing for which the incident direction is determined is, for example, a swing performed before impact. The time before impact is, for example, a section from a halfway-down to the impact of the golf club 3. For example, the incident direction determination unit 214 determines the incident direction of the trajectory of the golf club 3 on the V zone during this section.

As the incident direction of the trajectory of the golf club 3 on the V zone before the impact, there are a direction in which the trajectory is incident on the V zone from the shaft plane 30 and a direction in which the trajectory is incident on the V zone from the Hogan's plane 40. As the incident direction of the trajectory of the golf club 3 on the V zone before the impact, there is also a direction in which the trajectory is not incident from either the shaft plane 30 nor the Hogan's plane 40. That is, the trajectory of the golf club 3 is within the V zone before the halfway-down and passes directly up to the position of the impact without deviation from the V zone in some cases (in other words, the trajectory of the golf club 3 is within the V zone from the halfway-down to the impact in some cases). The incident direction determination unit 214 determines the three incident directions of the trajectory of the golf club 3 calculated by the exercise analysis unit 213 before the impact.

The type determination unit 215 determines a type of swing of the user 2 based on the incident direction of the trajectory of the golf club 3 on the V zone which is determined by the incident direction determination unit 214.

Here, when the head of the golf club 3 is incident on the V zone from the shaft plane 30 before the impact, hitting is generally slice in many cases. When the head of the golf club 3 is incident on the V zone from the Hogan's plane 40 before the impact, hitting is generally hook in many cases. When the head of the golf club 3 is within the V zone before the impact, hitting is generally straight in many cases. Thus, when the incident direction determination unit 214 determines that the trajectory of the golf club 3 is incident on the V zone from the shaft plane 30, the type determination unit 215 determines that a type of swing of the user is the type of slice. Further, when the incident direction determination unit 214 determines that the trajectory of the golf club 3 is incident on the V zone from the Hogan's plane 40, the type determination unit 215 determines that a type of swing of the user is the type of hook. Furthermore, when the incident direction determination unit 214 determines that the trajectory of the golf club 3 is not incident on the V zone from either the shaft plane 30 nor the Hogan's plane 40 (when it is determined that the trajectory of the golf club 3 normally passes through the V zone before the impact), the type determination unit 215 determines that a type of swing of the user is the type of straight.

The image generation unit 216 performs a process of generating image data corresponding to an image of an exercise analysis result displayed on the display unit 25. In particular, in the embodiment, the image generation unit 216 generates image data including the shaft plane 30 specified by first imaginary plane specifying unit 211, the Hogan's plane 40 specified by the second imaginary plane specifying unit 212, and the trajectory of the golf club 3 at a swing (in particular, a downswing) of the user 2, which is calculated by the exercise analysis unit 213. For example, the image generation unit 216 generates polygon data of the shaft plane 30 having the four vertexes T1, T2, S1, and S2 illustrated in FIG. 2 based on information regarding the coordinates of T1, T2, S1, and S2 and generates polygon data of the Hogan's plane 40 having the four vertexes T1, T2, H1, and H2 based on information regarding the coordinates of T1, T2, H1, and H2. The image generation unit 216 generates curved-line data indicating the trajectory of the golf club 3 at the time of a downswing of the user 2. Then, the image generation unit 216 generates image data including the polygon data of the shaft plane 30, the polygon data of the Hogan's plane 40, and the curved-line data indicating the trajectory of the golf club 3. At this time, the image generation unit 216 may include information regarding the type of swing determined by the type determination unit 215 in the image data. Thus, the type of swing of the user 2 is displayed on the display unit 25 and the type of swing of the user 2 can be simply estimated by himself or herself.

The first imaginary plane specifying unit 211, the second imaginary plane specifying unit 212, the exercise analysis unit 213, the incident direction determination unit 214, the type determination unit 215, and the image generation unit 216 also perform a process of storing various kinds of calculated information and the like in the storage unit 24.

The output processing unit 217 performs a process of causing the display unit 25 to display various images (including not only an image corresponding to the image data generated by the image generation unit 216 but also text or signs or the like). For example, the output processing unit 217 causes the display unit 25 to display the image corresponding to the image data generated by the image generation unit 216 automatically or according to an input operation of the user 2 after a swing exercise of the user 2 ends. Alternatively, the sensor unit 10 may include a display unit, the output processing unit 217 may transmit the image data to the sensor unit 10 via the communication unit 22, and various images may be displayed on the display unit of the sensor unit 10.

The output processing unit 217 performs a process of causing the sound output unit 26 to output various kinds of audio (also including sound or buzzer tone or the like). For example, the output processing unit 217 reads various kinds of information stored in the storage unit 24 and causes the sound output unit 26 to output audio or sound for exercise analysis automatically or at the time of performing a predetermined input operation after a swing exercise of the user 2 ends. Alternatively, the sensor unit 10 may include a sound output unit, the output processing unit 217 may transmit various kinds of audio data or sound data to the sensor unit 10 via the communication unit 22, and the sound output unit of the sensor unit 10 may be caused to output the various kinds of audio or sound.

The exercise analysis device 20 or the sensor unit 10 may include a vibration mechanism and various kinds of information may be converted into vibration information by the vibration mechanism to be presented to the user 2.

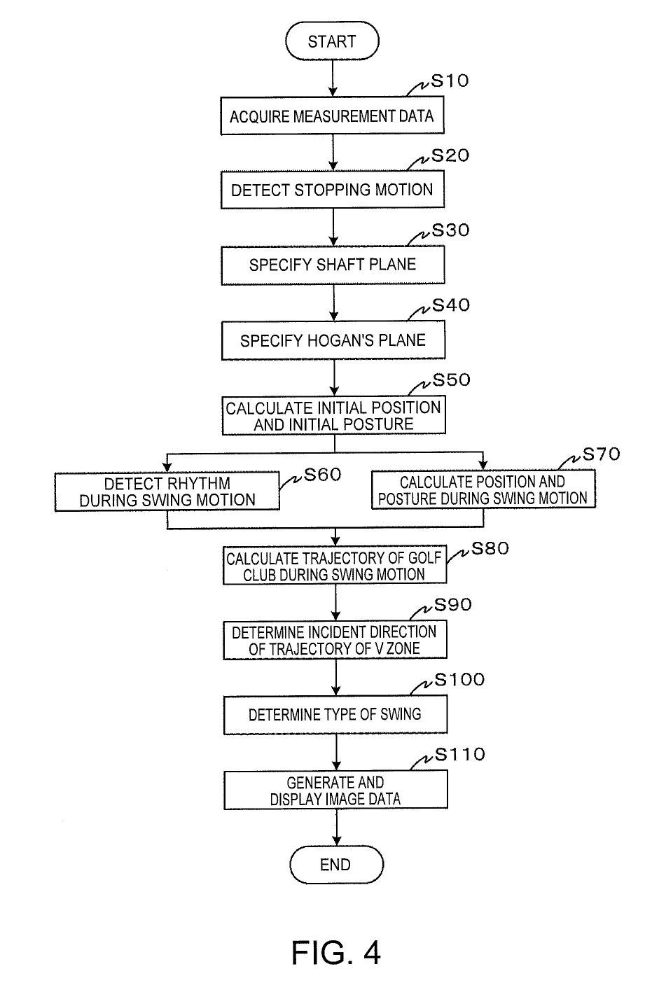

FIG. 4 is a flowchart illustrating an example of an exercise analysis process. The control unit 21 executes an exercise analysis program stored in the storage unit 24 to perform the exercise analysis process in the procedure of the flowchart illustrated in FIG. 4.

First, the sensor information acquisition unit 210 acquires the measurement data of the sensor unit 10 (step S10). When the control unit 21 acquires the first measurement data in a swing exercise (also including a stopping motion) of the user 2, the control unit 21 may perform processes subsequent to step S20 in real time. Alternatively, after the control unit 21 acquires some or all of the series of measurement data in the swing exercise of the user 2 from the sensor unit 10, the control unit 21 may perform the processes subsequent to step S20.

Next, the exercise analysis unit 213 detects a stopping motion (address motion) of the user 2 using the measurement data acquired from the sensor unit 10 (step S20). When the control unit 21 performs the process in real time and detects the stopping motion (address motion), for example, the control unit 21 outputs a predetermined image or audio. Alternatively, the sensor unit 10 may include an LED and blinks the LED to notify the user 2 that the stopped state is detected so that the user 2 confirms the notification and subsequently starts a swing.

Next, the first imaginary plane specifying unit 211 specifies the shaft plane 30 (the first imaginary plane) using the measurement data (the measurement data in the stopping motion (address motion) of the user 2) acquired from the sensor unit 10 and the club specification information (step S30).

Next, the second imaginary plane specifying unit 212 specifies the Hogan's plane 40 (the second imaginary plane) using the measurement data (the measurement data in the stopping motion (address motion) of the user 2) acquired from the sensor unit 10 and the body information (step S40).

Next, the exercise analysis unit 213 calculates the initial position and the initial posture of the sensor unit 10 using the measurement data (the measurement data in the stopping motion (address motion) of the user 2) acquired from the sensor unit 10 (step S50).

Next, the exercise analysis unit 213 detects a series of motions (rhythm) from the start of the swing to the end of the swing using the measurement data acquired from the sensor unit 10 (step S60).

The exercise analysis unit 213 calculates the position and posture of the sensor unit 10 during the swing motion of the user 2 concurrently with the process of step S60 (step S70).

Next, the exercise analysis unit 213 calculates the trajectory of the golf club 3 during the swing motion of the user 2 using the rhythm detected in step S60 and the position and posture of the sensor unit 10 calculated in step S70 (step S80).

Next, the incident direction determination unit 214 determines the incident direction of the trajectory of the golf club 3 in the V zone (the region between the shaft plane 30 specified in step S30 and the Hogan's plane 40 specified in step S40) before the impact (step S90).

Next, the type determination unit 215 determines the type of swing of the user 2 based on the incident direction of the trajectory of the golf club 3 determined in step S90 (step S100).

Next, the image generation unit 216 generates the image data including the shaft plane 30 specified in step S30, the Hogan's plane 40 specified in step S40, the trajectory of the golf club at the time of the downswing calculated in step S80, and the information regarding the type of swing of the user 2 determined in step S100, and then the output processing unit 217 causes the display unit 25 to display the image data (step S110). Then, the control unit 21 ends the processes of the flowchart illustrated in FIG. 4.

In the flowchart of FIG. 4, the sequence of the processes may be appropriately changed within a possible range.

Next, an example of the process (the process of step S30 in FIG. 4) of specifying the shaft plane (the first imaginary plane) will be described in detail.

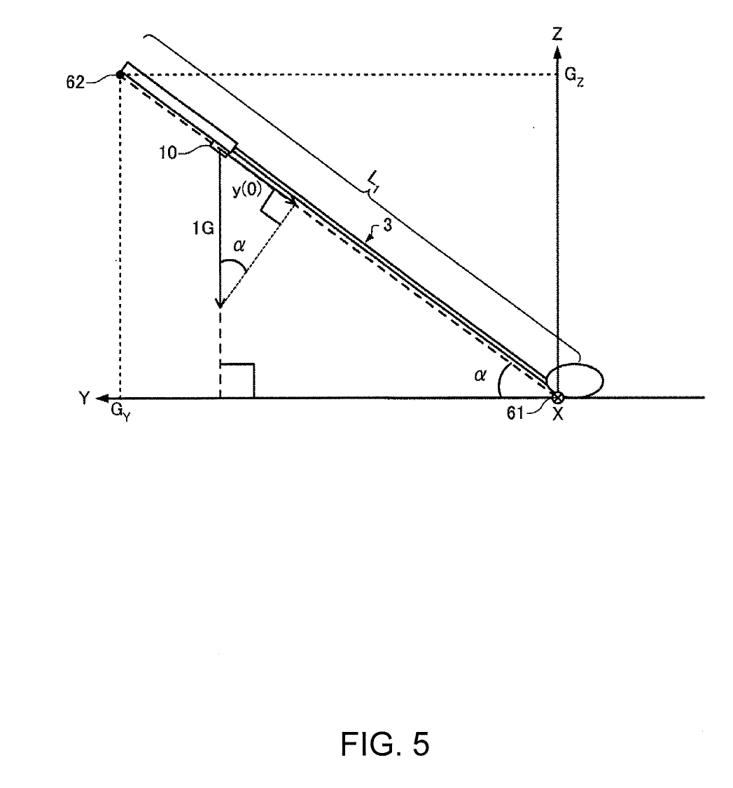

As illustrated in FIG. 2, the first imaginary plane specifying unit 211 first calculates the coordinates (0, G_{Y}, G_{Z}) of the position 62 of the grip end based on the acceleration data at the time of the stopping measured by the sensor unit 10 and the club specification information by using the position 61 of the head of the golf club 3 as the origin O (0, 0, 0) of the XYZ coordinate system (global coordinate system). FIG. 5 is a plan view illustrating the golf club 3 and the sensor unit 10 at the time of stopping of the user 2 (the time of the address) when viewed from the negative side of the X axis. In FIG. 5, the position 61 of the head of the golf club 3 is the origin O (0, 0, 0) and the coordinates of the position 62 of the grip end are (0, G_{Y}, G_{Z}). Since the gravity acceleration G is applied to the sensor unit 10 at the time of stopping of the user 2, a relation between the y axis acceleration y(0) and an inclination angle (an angle formed by the major axis of the shaft and the horizontal plane (XY plane)) α of the shaft of the golf club 3 is expressed in equation (1).

y(0)=G·sin α (1)

Accordingly, when L₁ is the length of the shaft of the golf club 3 included in the club specification information, G_{Y} and G_{Z} are calculated using the length L₁ and the inclination angle α of the shaft in equations (2) and (3), respectively.

G_{Y}=L₁·cos α (2)

G_{Z}=L₁·sin α (3)

Next, the first imaginary plane specifying unit 211 multiplies the coordinates (0, G_{Y}, G_{Z}) of the position 62 of the grip end of the golf club 3 by a scale factor S to calculate the coordinates (0, S_{Y}, S_{Z}) of a midpoint S3 of the vertexes S1 and S2 of the shaft plane 30. That is, S_{Y} and S_{Z} are calculated using equations (4) and (5).

S_{Y}=G_{Y}·S (4)

S_{Z}=G_{Z}·S (5)

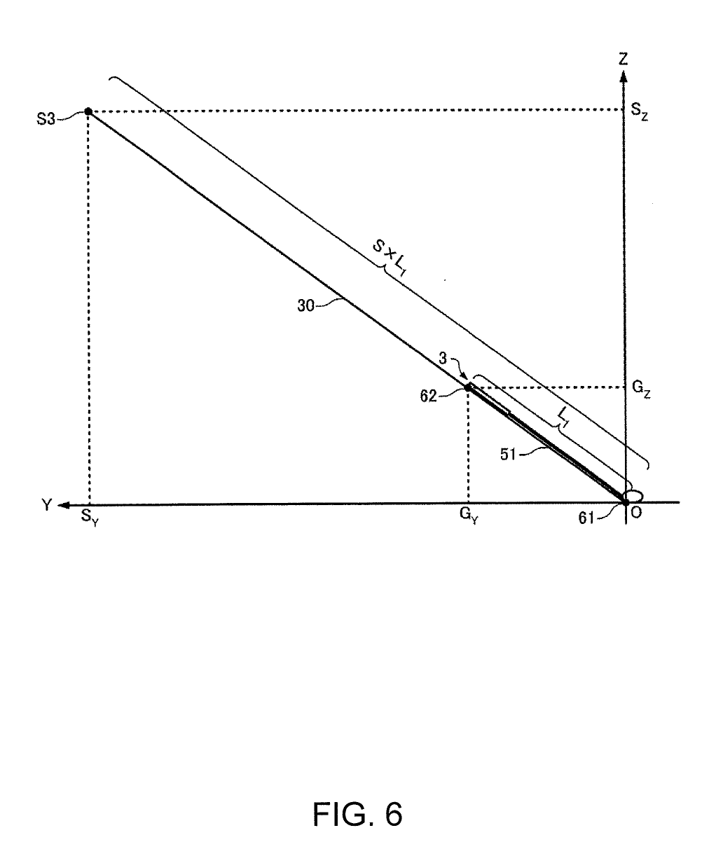

FIG. 6 is a diagram illustrating a cross section obtained by cutting the shaft plane 30 in FIG. 2 along the YZ plane when viewed from the negative side of the X axis. The length (the width of the shaft plane 30 in a direction perpendicular to the X axis) of a line segment connecting the origin O to the midpoint S3 of the vertexes S1 and S2 is S times the length L₁ of the first line segment 51. The scale factor S is set to a value so that the trajectory of the golf club 3 during the swing motion of the user 2 falls within the shaft plane 30. For example, when L₂ is the length of an arm of the user 2, the scale factor S may be set as in equation (6) so that a width S×L₁ in the direction perpendicular to the X axis of the shaft plane 30 is twice a sum of the length L₁ of the shaft and the length L₂ of the arm.

$$S = \frac{2 \cdot ( {L}_{1} + {L}_{2} )}{{L}_{1}} \qquad ( 6 )$$

The length L₂ of the arm of the user 2 has correlation with a height L₀ of the user 2. For example, based on statistical information, a correlation equation as in equation (7) is expressed when the user 2 is male, and a correlation equation as in equation (8) is expressed when the user 2 is female.

L₂=0.41×L₀−45.5 [mm] (7)

L₂=0.46×L₀−126.9 [mm] (8)

Accordingly, the length L₂ of the arm of the user is calculated by equation (7) or (8) using the height L₀ and sex of the user 2 included in the body information.

Next, the first imaginary plane specifying unit 211 calculates the coordinates (−TL/2, 0, 0) of the vertex T1, the coordinates (TL/2, 0, 0) of the vertex T2, the coordinates (−TL/2, S_{Y}, S_{Z}) of the vertex S1, and the coordinates (TL/2, S_{Y}, S_{Z}) of the S2 of the shaft plane 30 using the coordinates (0, S_{Y}, S_{Z}) of the midpoint S3 calculated as described above and the width (the length of the third line segment 52) TL of the shaft plane 30 in the X axis direction. The width TL in the X axis direction is set to a value so that the trajectory of the golf club 3 during the swing motion of the user 2 falls within the shaft plane 30. For example, the width TL in the X axis direction may be set to be the same as the width S×L₁ in the direction perpendicular to the X axis, that is, twice the sum of the length L₁ of the shaft and the length L₂ of the arm.

The shaft plane 30 is specified based on the coordinates of the four vertexes T1, T2, S1, and S2 calculated in this way.

Next, an example of the process (the process of step S40 in FIG. 4) of specifying the Hogan's plane (the second imaginary plane) will be described in detail.

First, the second imaginary plane specifying unit 212 estimates the predetermined position 63 on the line segment connecting both shoulders of the user 2 to one another to calculate the coordinates (A_{X}, A_{Y}, A_{Z}), using the coordinates (0, G_{Y}, G_{Z}) of the position 62 of the grip end of the golf club 3 calculated as described above and the body information of the user 2.

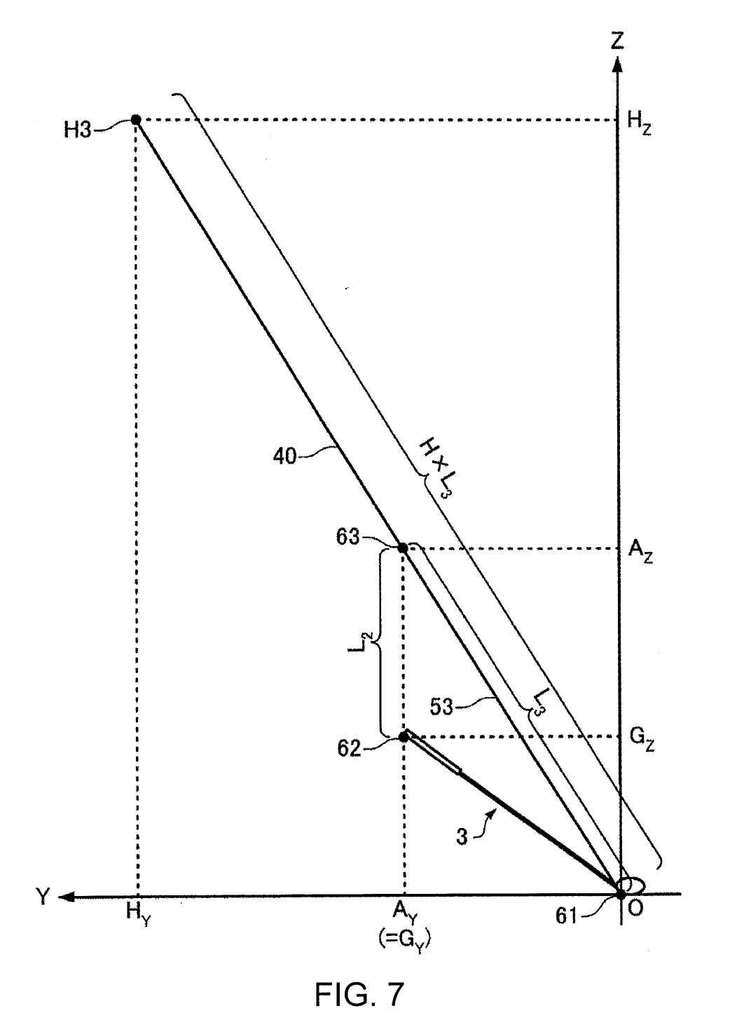

FIG. 7 is a diagram illustrating a cross section obtained by cutting the Hogan's plane 40 in FIG. 2 along the YZ plane when viewed from the negative side of the X axis. In FIG. 7, the midpoint of the line segment connecting both shoulders of the user 2 to one another is set as the predetermined position 63, and the predetermined position 63 is present on the YZ plane. Accordingly, the X coordinate A_{X} of the predetermined position 63 is 0. Then, the second imaginary plane specifying unit 212 estimates that a position obtained by moving the position 62 of the grip end of the golf club 3 by the length L₂ of the arm of the user 2 in the positive direction of the Z axis is the predetermined position 63. Accordingly, the Y coordinate A_{Y} of the predetermined position 63 is the same as the Y coordinate G_{Y} of the position 62 of the grip end, and the Z coordinate A_{Z} of the predetermined position 63 is calculated as a sum of the Z coordinate G_{Z} of the position 62 of the grip end and the length L₂ of the arm of the user 2, as in equation (9).

A_{Z}=G_{Z}+L₂ (9)

The length L₂ of the arm of the user is calculated in equation (7) or (8) using the height L₀ and sex of the user 2 included in the body information.

Next, the second imaginary plane specifying unit 212 multiples the Y coordinate A_{Y} and the Z coordinate A_{Z} of the predetermined position 63 by a scale factor H to calculate the coordinates (0, H_{Y}, H_{Z}) of a midpoint H3 of the vertexes H1 and H2 of the Hogan's plane 40. That is, H_{Y} and H_{Z} are calculated using equations (10) and (11).

H_{Y}=A_{Y}·H (10)

H_{Z}=A_{Z}·H (11)

As illustrated in FIG. 7, a length (a width of the Hogan's plane 40 in a direction perpendicular to the X axis) of a line segment connecting the origin O to the midpoint H3 of the vertexes H1 and H2 is H times the length L₃ of the second line segment 53. The scale factor H is set to a value so that the trajectory of the golf club 3 during the swing motion of the user 2 falls within the Hogan's plane 40. For example, the Hogan's plane 40 may have the same shape and size as the shaft plane 30. In this case, since a width H×L₃ of the Hogan's plane 40 in the direction perpendicular to the X axis is identical to the width S×L₁ of the shaft plane 30 in the direction perpendicular to the X axis and is twice the sum of the length L₁ of the shaft of the golf club 3 and the length L₂ of the arm of the user 2, the scale factor H may be set as in equation (12).

$$H = \frac{2 \cdot ( {L}_{1} + {L}_{2} )}{{L}_{3}} \qquad ( 12 )$$

The length L₃ of the second line segment 53 is calculated from equation (13) using the Y coordinate A_{Y} and the Z coordinate A_{Z} of the predetermined position 63.

L₃=\sqrt{A_{Y}²+A_{Z}²} (13)

Next, the second imaginary plane specifying unit 212 calculates the coordinates (−TL/2, 0, 0) of the vertex T1, the coordinates (TL/2, 0, 0) of the vertex T2, the coordinates (−TL/2, H_{Y}, H_{Z}) of the vertex H1, and the coordinates (TL/2, H_{Y}, H_{Z}) of the H2 of the Hogan's plane 40 using the coordinates (0, H_{Y}, H_{Z}) of the midpoint H3 calculated as described above and the width (the length of the third line segment 52) TL of the Hogan's plane 40 in the X axis direction. The width TL in the X axis direction is set to a value so that the trajectory of the golf club 3 during the swing motion of the user 2 falls within the Hogan's plane 40. In the embodiment, the width TL of the Hogan's plane 40 in the X axis direction may be set to be the same as the width of the shaft plane 30 in the X axis direction, and thus may be set to be twice the sum of the length L₁ of the shaft and the length L₂ of the arm, as described above.

The Hogan's plane 40 is specified based on the coordinates of the four vertexes T1, T2, H1, and H2 calculated in this way.

Next, an example of the process (the process of step S60 in FIG. 4) of detecting a timing at which the user 2 hits a ball will be described in detail.

The exercise analysis unit 213 detects a series of motions (also referred to as a rhythm) from the start of the swing to the end of the swing, for example, the start of the swing, a backswing, a top, a downswing, an impact, follow-through, and the end of the swing, using the measurement data acquired from the sensor unit 10. A specific rhythm detection procedure is not particularly limited. For example, the following procedure can be adopted.

First, the exercise analysis unit 213 calculates a sum (referred to as a norm) of the magnitudes of the angular velocities around the axes at each time t using the acquired angular velocity data of each time t. The exercise analysis unit 213 may integrate the norm of the angular velocities at each time t by time.

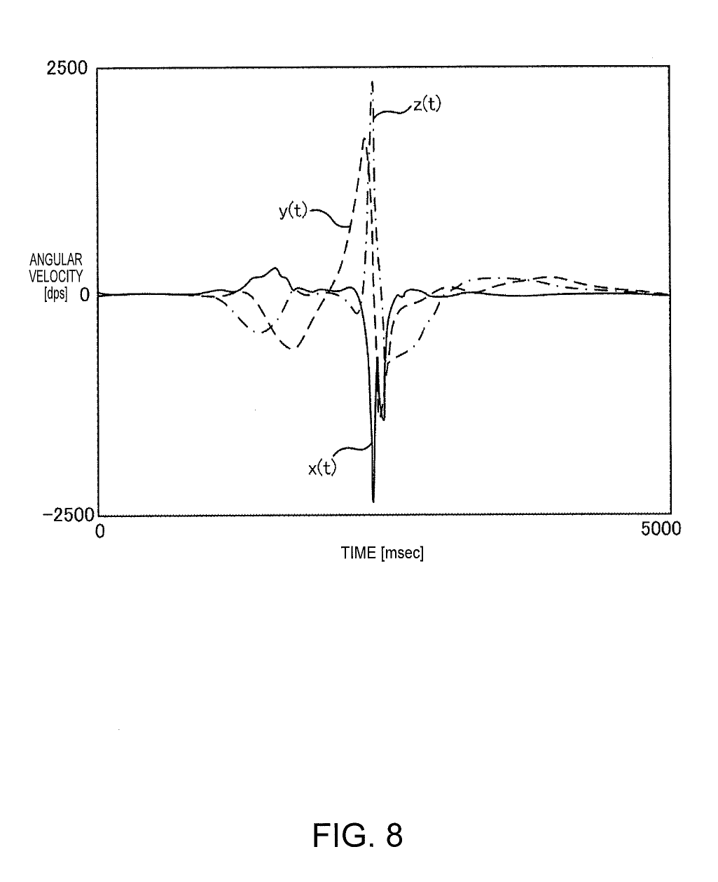

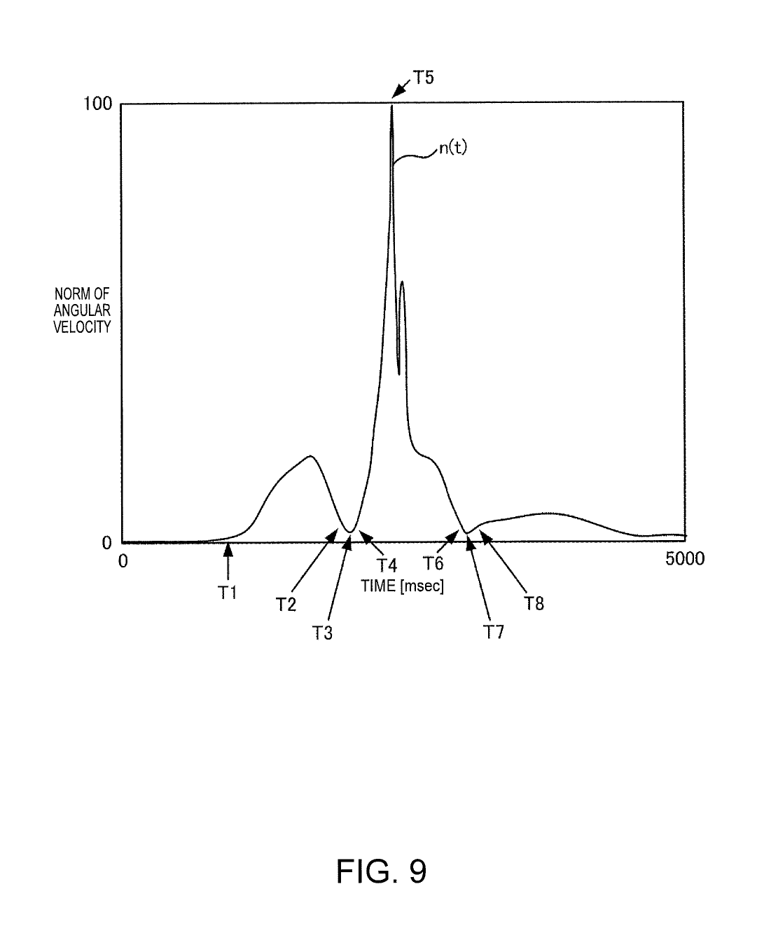

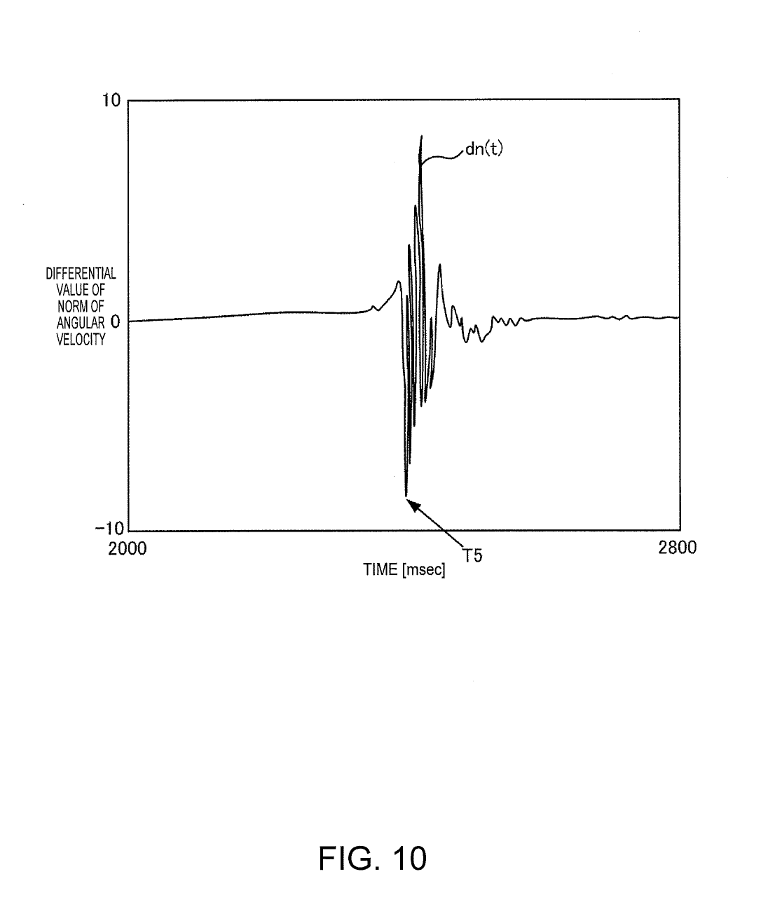

Here, a case of a graph in which angular velocities around three axes (x, y, and z axes) is shown, for example, in FIG. 8 (which is a diagram illustrating examples of angular velocities output from the sensor unit) will be considered. In FIG. 8, the horizontal axis represents a time (msec) and the vertical axis represents an angular velocity (dps). The norm of the angular velocities is shown in the graph illustrated in, for example, FIG. 9 (which is a diagram illustrating an example of the norm of the angular velocities). In FIG. 9, the horizontal axis represents a time (msec) and the vertical axis represents the norm of the angular velocities. A differential value of the norm of the angular velocity is shown in a graph illustrated in, for example, FIG. 10 (which is a diagram illustrating an example of the differential value of the norm of the angular velocity). In FIG. 10, the horizontal axis represents a time (msec) and the vertical axis represents the differential value of the norm of the vertical angular. FIGS. 8 to 10 are exemplified to facilitate understanding of the embodiment and do not show accurate values.

The exercise analysis unit 213 detects a timing of an impact in the swing using the calculated norm of the angular velocities. For example, the exercise analysis unit 213 detects a timing at which the norm of the angular velocities is the maximum as the timing of the impact (T5 in FIG. 9). For example, the exercise analysis unit 213 may detect a former timing between timings at which the value of the differential of the calculated norm of the angular velocities is the maximum and the minimum as the timing of the impact (T5 in FIG. 10).

For example, the exercise analysis unit 213 detects a timing at which the calculated norm of the angular velocities is the minimum before the impact as a timing of a top of the swing (T3 in FIG. 9). For example, the exercise analysis unit 213 specifies a period in which the norm of the angular velocities is continuously equal to or less than a first threshold value before the impact, as a top period (which is an accumulation period at the top) (T2 to T4 in FIG. 9).

For example, the exercise analysis unit 213 detects a timing at which the norm of the angular velocities is equal to or less than a second threshold value before the top, as a timing of the start of the swing (T1 in FIG. 9).

For example, the exercise analysis unit 213 detects a timing at which the norm of the angular velocities is the minimum after the impact, as a timing of the end (finish) of the swing (T7 in FIG. 9). For example, the exercise analysis unit 213 may detect a first timing at which the norm of the angular velocities is equal to or less than the third threshold value after the impact, as the timing of the end (finish) of the swing. For example, the exercise analysis unit 213 specifies a period in which the norm of the angular velocities is continuously equal to or less than a fourth threshold value after the timing of the impact and close to the timing of the impact, as a finish period (T6 to T8 in FIG. 9).

In this way, the exercise analysis unit 213 can detect the rhythm of the swing. The exercise analysis unit 213 can specify each period (for example, a backswing period from the start of the swing to the start of the top, a downswing period from the end of the top to the impact, and a follow-through period from the impact to the end of the swing) during the swing by detecting the rhythm.

The exercise analysis unit 213 can specify, for example, a period from the halfway-down to the impact as the time before impact. A timing of the halfway-down can be detected when the sensor unit 10 mounted on the golf club 3 detects that the golf club 3 is horizontal.

Hereinafter, the incident direction determination unit 214 and the type determination unit 215 will be described in detail.

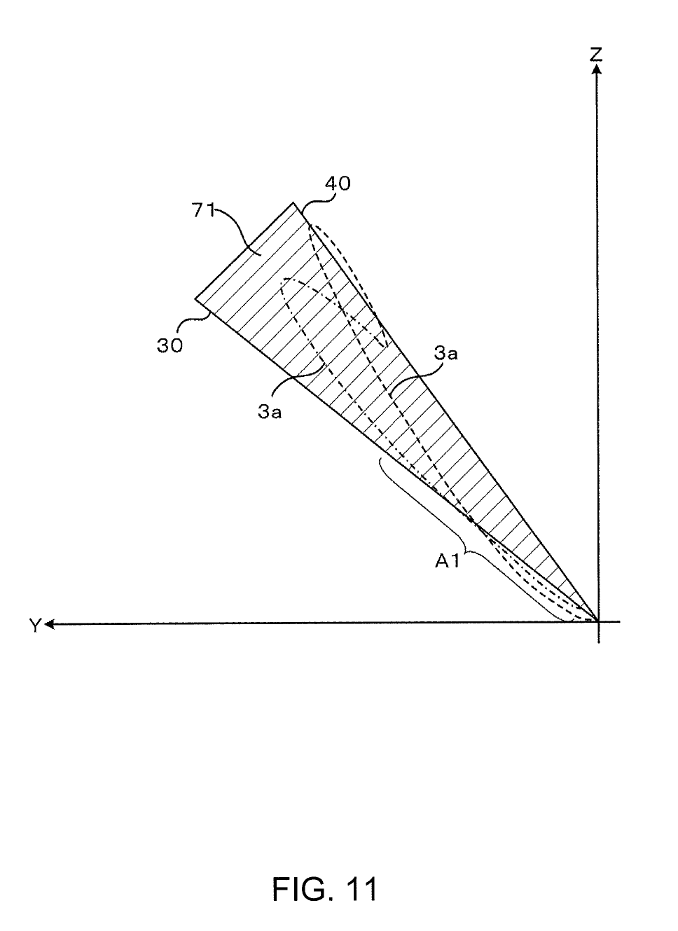

FIG. 11 is a diagram (a diagram projected to the YZ plane) illustrating the shaft plane and the Hogan's plane when viewed from the negative side of the X axis. In FIG. 11, the shaft plane 30, the Hogan's plane 40, and a trajectory 3a of the golf club 3 are illustrated. The trajectory 3a indicated by a dotted line of FIG. 11 is a trajectory of the golf club 3 in a backswing and the trajectory 3a indicated by a one-dot chain line is a trajectory of the golf club 3 in a downswing.

The trajectory 3a indicated by the one-dot chain line shown in a range A1 of FIG. 11 is a trajectory before impact. For example, the trajectory 3a indicated by the one-dot chain line shown in the range A1 is a trajectory from the halfway-down to the impact.

The incident direction determination unit 214 specifies a region (a V zone 71 indicated by diagonal lines of FIG. 11) interposed between the shaft plane 30 specified by the first imaginary plane specifying unit 211 and the Hogan's plane 40 specified by the second imaginary plane specifying unit 212. Then, the incident direction determination unit 214 determines the incident direction of the trajectory 3a of the golf club 3 on the V zone 71 before the impact.

For example, in the case of FIG. 11, the trajectory 3a (the trajectory 3a indicated by the one-dot chain line shown in the range A1) before the impact is incident on the V zone 71 from the shaft plane 30. Accordingly, in the case of the example of FIG. 11, the incident direction determination unit 214 determines that the trajectory 3a of the golf club 3 is incident on the V zone 71 from the shaft plane 30.

The type determination unit 215 determines the type of swing of the user 2 based on the determination result of the incident direction determination unit 214. In the case of the example of FIG. 11, since the incident direction determination unit 214 determines that the trajectory 3a of the golf club 3 is incident on the V zone 71 from the shaft plane 30, the type determination unit 215 determines that the type of swing of the user 2 is the slice type.

As described above, a time before the impact is detected by the exercise analysis unit 213. Accordingly, the incident direction determination unit 214 can specify the trajectory 3a before the impact based on the trajectory 3a calculated by the exercise analysis unit 213 and the time before the impact detected by the exercise analysis unit 213.

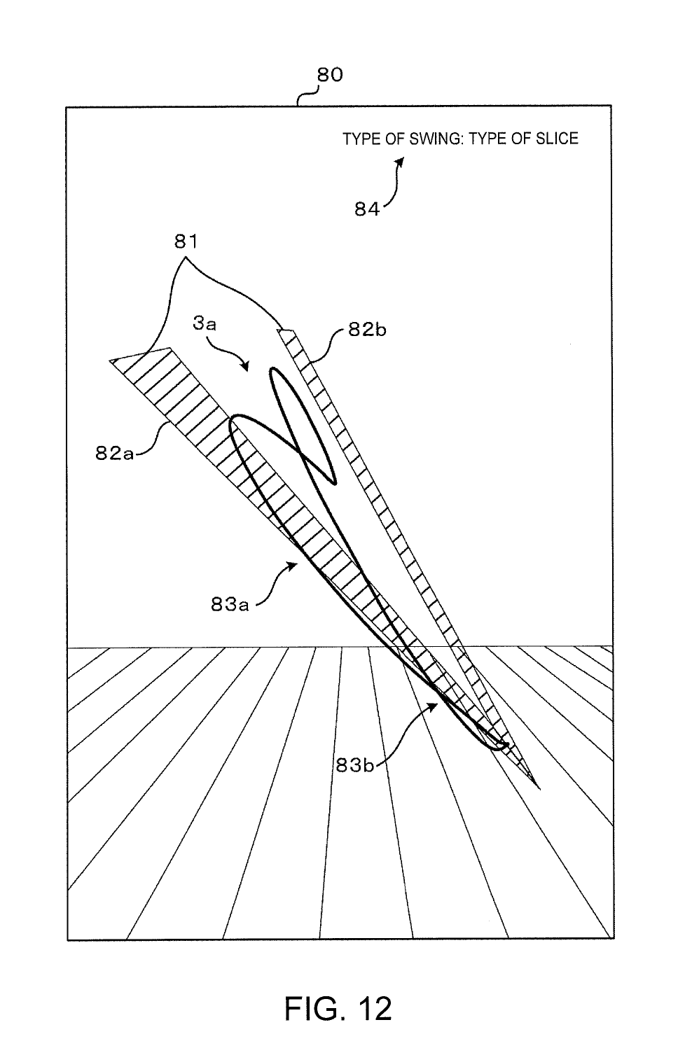

FIG. 12 is a diagram illustrating an example of a screen displayed on a display unit. The image data generated by the image generation unit 216 is output to the display unit 25 by the output processing unit 217. A screen 80 illustrated in FIG. 12 is a screen example displayed on the display unit 25. The screen 80 is a screen example viewed from the rear side in the hitting direction.

In the screen 80, a V zone 81 is shown. The V zone 81 is indicated by polygon data 82a of the shaft plane 30 and polygon data 82b of the Hogan's plane 40.

In the screen 80, the trajectory 3a from address of the golf club 3 to impact is shown. In the example of the screen 80 in FIG. 12, as indicated by an arrow 83a, the trajectory 3a of the golf club 3 is out of the V zone 81 from the shaft plane 30 (the polygon data 82a) during a downswing. As indicated by an arrow 83b, the trajectory 3a of the golf club 3 is incident on the V zone 81 from the shaft plane 30 (the polygon data 82a) before the impact. That is, in the example of the screen 80, the incident direction of the trajectory 3a of the golf club 3 is a direction from the shaft plane 30 to the V zone 81 before the impact. Accordingly, the type of swing of the user 2 is the type of slice in the example of the screen 80.

In the screen 80, a type of swing 84 indicating the type of swing of the user 2 is displayed. As described above, in the example of the trajectory 3a of the screen 80, the type of swing of the user 2 is the type of slice, and thus “TYPE OF SLICE” is displayed in a type of swing 84.

The image illustrated in FIG. 12 may be a 3-dimensional image of which a display angle (viewpoint at which an image is viewed) can be changed according to an operation of the user 2.

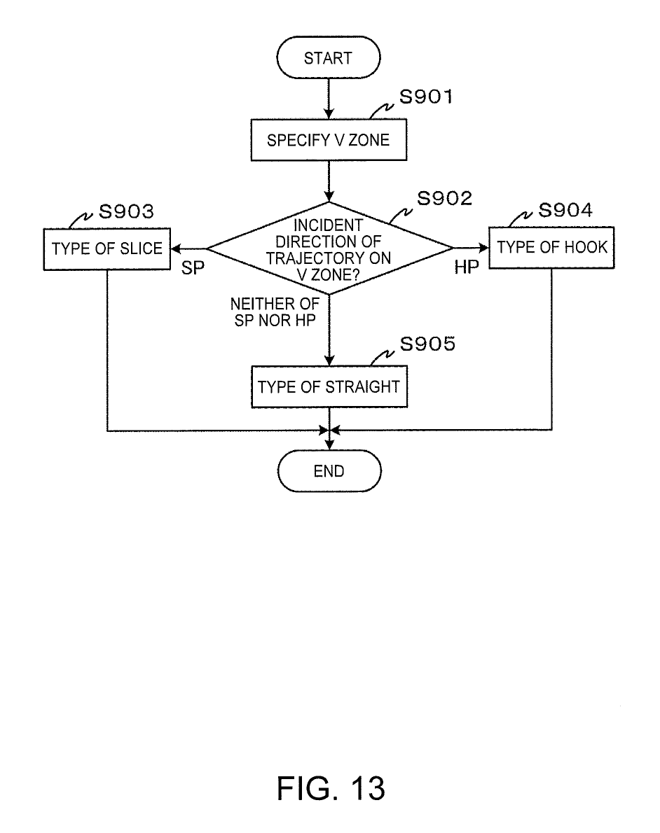

FIG. 13 is a flowchart illustrating an example of operations of the incident direction determination unit and the type determination unit. The flowchart of FIG. 13 is a flowchart illustrating the detailed processes of steps S90 and S100 of FIG. 4.

First, the incident direction determination unit 214 specifies the V zone based on the shaft plane 30 specified in step S30 of FIG. 4 and the Hogan's plane 40 specified in step S40 of FIG. 4 (step S901).

Next, the incident direction determination unit 214 determines the incident direction of the trajectory of the golf club 3 calculated in step S80 of FIG. 4 on the V zone specified in step S901 before the impact (step S902). When the incident direction determination unit 214 determines that the trajectory of the golf club 3 is incident from the shaft plane 30 before the impact (“SP” of S902), the process proceeds to the process of step S903. When the incident direction determination unit 214 determines that the trajectory of the golf club 3 is incident on the Hogan's plane 40 before the impact (“HP” of S902), the process proceeds to step S904. When the incident direction determination unit 214 determines that the trajectory of the golf club 3 is not incident from either the shaft plane 30 nor the Hogan's plane 40 before the impact (“neither of SP nor HP” of S902), the process proceeds to step S905.

When the incident direction determination unit 214 determines that the trajectory of the golf club 3 is incident from the shaft plane 30 before the impact in step S902 (“SP” of S902), the type determination unit 215 determines that the type of swing of the user 2 is the “type of slice” (step S903). Then, the exercise analysis device 20 ends the process of the flowchart of FIG. 13.

When the incident direction determination unit 214 determines that the trajectory of the golf club 3 is incident from the Hogan's plane 40 before the impact in step S902 (“HP” of S902), the type determination unit 215 determines that the type of swing of the user 2 is the “type of hook” (step S904). Then, the exercise analysis device 20 ends the process of the flowchart of FIG. 13.

When the incident direction determination unit 214 determines that the trajectory of the golf club 3 is not incident from either the shaft plane 30 nor the Hogan's plane 40 before the impact in step S902 (“neither of SP nor HP” of S902), the type determination unit 215 determines that the type of swing of the user 2 is the “type of straight” (step S905). Then, the exercise analysis device 20 ends the process of the flowchart of FIG. 13.

When the exercise analysis device 20 ends the process of the flowchart of FIG. 13, the exercise analysis device 20 performs the process of step S110 of FIG. 4. Thus, the image generation unit 216 can include the result of the type of swing determined in steps S903 to S905 by the type determination unit 215 in the image data, and thus can display the determination results of steps S903 to S905 in the type of swing 84 of the screen 80 described in FIG. 12.

As described above, the exercise analysis device 20 determines the incident direction of the trajectory of the golf club 3 on the V zone before the impact. Thus, the user 2 can simply estimate the type of swing.

Since the exercise analysis device 20 specifies the shaft plane 30 and the Hogan's plane 40 using the sensor unit 10, it is not necessary to use a large-scale device such as a camera and restriction on a place where the type of swing is estimated is small.

The foregoing type determination unit 215 may determine the type of swing of the user 2 based on incident directions of trajectories of the golf club 3 in a plurality of swings. For example, the type determination unit 215 stores the incident directions in the 10 previous swings in the storage unit 24. Then, the type determination unit 215 determines the type of swing of the user 2 based on the most incident directions among the incident directions in the 10 previous swings. Specifically, it is assumed that, of the 10 previous swings, the number of incident directions from the shaft plane 30 is 5 times, the number of incident directions from the Hogan's plane 40 is twice, and the number of cases from neither the shaft plane 30 nor the Hogan's plane 40 is 3 times. In this case, the type determination unit 215 determines that the type of swing of the user 2 is the type of slice. Thus, the user can recognize his or her swing tendency. The type determination unit 215 may output the determination results of the types of swing of the user 2 in a plurality of swings and the determination result of the type of recent swing of the user 2. Thus, the user 2 can compare his or her tendency of the type of swing to the type of recent swing.

As described above, the exercise analysis device 20 determines the incident direction of the trajectory of the golf club 3 before the impact, but may determine an exit direction of the trajectory of the golf club 3 from the V zone after the impact. Then, the exercise analysis device 20 may determine the type of swing of the user 2 based on the incident direction and the exit direction of the trajectory of the golf club 3.

For example, the exercise analysis device 20 includes an exit direction determination unit. The exit direction determination unit determines whether the trajectory of the golf club 3 exits from the shaft plane 30, exits from the Hogan's plane 40, exits from neither the shaft plane 30 nor the Hogan's plane 40 in a section up to a predetermined time from after impact (that is, the trajectory normally passes through the V zone up to the predetermined time from after the impact). Then, the type determination unit 215 determines the type of swing of the user 2 based on the incident direction of the trajectory of the golf club 3 by the incident direction determination unit 214 and the exit direction of the trajectory of the golf club 3 by the exit direction determination unit. For example, the type determination unit 215 determines whether the type of swing of the user 2 is the type of slice, the type of hook, the type of fade, the type of draw, or the type of straight. In this way, the exercise analysis device 20 can estimate the type of swing more minutely by determining the type of swing of the user 2 based on the incident direction and the exit direction of the trajectory of the golf club 3.

As described above, the type of swing 84 of the user 2 is displayed in the screen 80 in which the V zone 81 and the trajectory 3a of the golf club 3 are displayed, but the invention is not limited thereto. For example, an item “type of swing” of the user 2 may be provided in a menu screen. For example, when this item is tapped, the image generation unit 216 may display the type of swing of the user 2 on the display unit 25.

As described above, the second imaginary plane specifying unit 212 specifies the second line segment 53 using the body information and the measurement data output by the sensor unit 10. However, a process of specifying the second line segment 53 connecting the positions 63 and 62 of the head (the blow portion) of the golf club 3 may be performed using the first line segment 51 specified by the first imaginary plane specifying unit 211 and the predetermined angle θ relative to the first line segment 51.

As described above, the Hogan's plane 40 is specified by the output of the sensor unit 10 fitted in the golf club 3, but the invention is not limited thereto. For example, a sensor unit may be fitted in an arm or the like of the user 2 and the Hogan's plane 40 may be specified based on an output of the sensor unit.

As described above, the acceleration sensor 13 and the angular velocity sensor 14 are embedded in the sensor unit 10 to be integrated, but the acceleration sensor 13 and the angular velocity sensor 14 may not be integrated.

Alternatively, the acceleration sensor 13 and the angular velocity sensor 14 may not be embedded in the sensor unit 10, but may be mounted directly on the golf club 3 or the user 2. In the foregoing embodiments, the sensor unit 10 and the exercise analysis device 20 are separated, but the sensor unit 10 and the exercise analysis device 20 may be integrated to be mounted on the golf club 3 or the user 2.

In the foregoing embodiments, the exercise analysis device 20 calculates the Z coordinate A_{Z} of the predetermined position 63 on the line segment connecting both shoulders of the user 2 to one another as the sum of the Y coordinate G_{Y} of the position 62 of the grip end and the length L₂ of the arm of the user 2 as in equation (9), but another equation may be used. For example, the exercise analysis device 20 may multiply L₂ by a coefficient K and adds G_{Y} to calculate A_{Z} as in A_{Z}=G_{Y}+K·L₂.

The exercise analysis system (the exercise analysis device) analyzing a golf swing has been exemplified above. However, the invention can be applied to an exercise analysis system (exercise analysis device) analyzing swings of various exercises of tennis, baseball, and the like.

The functional configuration of the exercise analysis system described above is classified according to main processing content in order to facilitate understanding of the configuration of the exercise analysis system. The invention is not limited by the method of classifying the constituent elements or the names of the constituent elements. The configuration of the exercise analysis system can be classified into further many constituent elements according to the processing content. One constituent element can be classified to perform more processes. The process of each constituent element may be performed by one piece of hardware or may be performed by a plurality of pieces of hardware.

Units of processes in the flowcharts described above are divided according to main processing content in order to facilitate understanding of the process of the exercise analysis device. The invention is not limited by a method of dividing the units of processes or the names of the units of processes. The process of the exercise analysis device can be divided in more units of processes according to the processing content. One unit of process can be divided to include more processes. The processing procedure of the foregoing flowchart is not limited to the example illustrated in the drawing.

The embodiments of the invention have been described above, but the technical scope of the invention is not limited to the scope described in the foregoing embodiments. It should be apparent to those skill in the art that various modifications or improvements of the foregoing embodiments are made. It should be apparent from the description of the appended claims that the modifications or the improvements are also included in the technical scope of the invention. The invention can also be provided as an exercise analysis method, a program for the exercise analysis device, or a recording medium storing the program.

The entire disclosure of Japanese Patent Application No. 2014-256611, filed Dec. 18, 2014 is expressly incorporated by reference herein.

What is claimed is:

1. An exercise analysis device comprising:
a first specifying unit that specifies a first axis which lies in a longitudinal direction of a shaft of an exercise tool at an address posture of a user, using an output of an inertial sensor;
a second specifying unit that specifies a second axis forming a predetermined angle along with the first axis, using a hitting direction as a rotation axis;
an analysis unit that calculates a trajectory of a swing of the user based on an output of the inertial sensor; and
an incident direction determination unit that determines an incident direction of the trajectory on a region specified based on the first and second axes in a downswing.

2. The exercise analysis device according to claim 1, further comprising:
a type determination unit that determines a type of swing of the user based on the incident direction.

3. The exercise analysis device according to claim 2,
wherein the first specifying unit specifies a first imaginary plane including the first axis and the hitting direction,
wherein the second specifying unit specifies a second imaginary plane including the second axis and the hitting direction, and
wherein when the trajectory is incident from the first imaginary plane, the type determination unit determines that the type of swing of the user is a type of slice,
wherein when the trajectory is incident from the second imaginary plane, the type determination unit determines that the type of swing of the user is a type of hook, and
wherein when the trajectory is not incident from either the first imaginary plane nor the second imaginary plane, the type determination unit determines that the type of swing of the user is a type of straight.

4. The exercise analysis device according to claim 2,
wherein a plurality of the trajectories of the swings are obtained, and
wherein the type determination unit determines the type of swing of the user based on the incident directions of the trajectories formed by the plurality of swings.

5. The exercise analysis device according to claim 1,
wherein the incident direction determination unit determines an incident direction of a section from a halfway-down to impact in the downswing.

6. The exercise analysis device according to claim 4,
wherein the incident direction determination unit determines an incident direction of a section from a halfway-down to impact in the downswing.

7. The exercise analysis device according to claim 1, further comprising:
an exit direction determination unit that determines an exit direction of the trajectory from the region after impact.

8. The exercise analysis device according to claim 7, further comprising:
a type determination unit that determines a type of swing of the user based on the incident direction of the trajectory and the exit direction of the trajectory.

9. The exercise analysis device according to claim 8,
wherein the first specifying unit specifies a first imaginary plane including the first axis and the hitting direction,
wherein the second specifying unit specifies a second imaginary plane including the second axis and the hitting direction,
wherein when the trajectory is incident from the first imaginary plane, the type determination unit determines that the type of swing of the user is a type of slice,
wherein when the trajectory is incident from the second imaginary plane, the type determination unit determines that the type of swing of the user is a type of hook, and
wherein when the trajectory is not incident from either the first imaginary plane nor the second imaginary plane, the type determination unit determines that the type of swing of the user is a type of straight.

10. The exercise analysis device according to claim 8,
wherein a plurality of the trajectories of the swings are obtained, and
wherein the type determination unit determines the type of swing of the user based on the incident directions of the trajectories formed by the plurality of swings.

11. An exercise analysis method comprising:
specifying a first axis which lies in a longitudinal direction of a shaft of an exercise tool at an address posture of a user, using an output of an inertial sensor;
specifying a second axis forming a predetermined angle along with the first axis, using a hitting direction as a rotation axis;
calculating a trajectory of a swing of the user based on an output of the inertial sensor; and
determining an incident direction of the trajectory on a region specified based on the first and second axes in a downswing.

12. A program causing a computer to perform:
specifying a first axis which lies in a longitudinal direction of a shaft of an exercise tool at an address posture of a user, using an output of an inertial sensor;
specifying a second axis forming a predetermined angle along with the first axis, using a hitting direction as a rotation axis;
calculating a trajectory of a swing of the user based on an output of the inertial sensor; and
determining an incident direction of the trajectory on a region specified based on the first and second axes in a downswing.

13. A recording medium that records a program causing a computer to perform:
specifying a first axis which lies in a major axis direction of a shaft of an exercise tool at an address posture of a user, using an output of an inertial sensor;
specifying a second axis forming a predetermined angle along with the first axis, using a hitting direction as a rotation axis;
calculating a trajectory of a swing of the user based on an output of the inertial sensor; and
determining an incident direction of the trajectory on a region specified based on the first and second axes in a downswing.

14. An exercise analysis system comprising:
an inertial sensor;
a first specifying unit that specifies a first axis which lies in a longitudinal direction of a shaft of an exercise tool at an address posture of a user, using an output of the inertial sensor;
a second specifying unit that specifies a second axis forming a predetermined angle along with the first axis, using a hitting direction as a rotation axis;
an analysis unit that calculates a trajectory of a swing of the user based on an output of the inertial sensor; and
an incident direction determination unit that determines an incident direction of the trajectory on a region specified based on the first and second axes in a downswing.

15. The exercise analysis system according to claim 14, further comprising:
a type determination unit that determines a type of swing of the user based on the incident direction.

16. The exercise analysis system according to claim 15,
wherein the first specifying unit specifies a first imaginary plane including the first axis and the hitting direction,
wherein the second specifying unit specifies a second imaginary plane including the second axis and the hitting direction, and
wherein when the trajectory is incident from the first imaginary plane, the type determination unit determines that the type of swing of the user is a type of slice,
wherein when the trajectory is incident from the second imaginary plane, the type determination unit determines that the type of swing of the user is a type of hook, and
wherein when the trajectory is not incident from either the first imaginary plane nor the second imaginary plane, the type determination unit determines that the type of swing of the user is a type of straight.

17. An exercise analysis device comprising:
an incident direction determination unit that determines an incident direction of a swing trajectory of a user on a V zone in a downswing.

18. The exercise analysis device according to claim 17, further comprising:
a type determination unit that determines a type of swing of the user based on the incident direction.

19. The exercise analysis device according to claim 18,
wherein a plurality of the swing trajectories are obtained, and
wherein the type determination unit determines the type of swing of the user based on the incident directions of the plurality of swing trajectories.

20. The exercise analysis device according to claim 17,
wherein the incident direction determination unit determines an incident direction of a section from a halfway-down to impact in the downswing.

21. The exercise analysis device according to claim 17, further comprising:
an exit direction determination unit that determines an exit direction of the swing trajectory from the V zone after impact.

22. The exercise analysis device according to claim 21, further comprising:
a type determination unit that determines a type of swing of the user based on the incident direction of the swing trajectory and the exit direction of the swing trajectory.
